(19) United States
(12) Patent Application Publication
(10) Pub. No.: US 2008/0065927 A1
(43) Pub. Date: Mar. 13, 2008

(54) CIRCUIT FOR CONTROLLING OPERATIONS OF UNIVERSAL SERIAL BUS (USB) DEVICE

(76) Inventor: Jin-Xiao Wu, Taipei Hsien (TW)

Correspondence Address: NORTH AMERICA INTELLECTUAL PROPERTY CORPORATION, P.O. BOX 506, MERRIFIELD, VA, 22116, US

(21) Appl. No.: 11/530,878

(22) Filed: Sep. 11, 2006

(51) Int. Cl. G06F 1/00

(52) U.S. Cl. 713/501

(57) ABSTRACT

A circuit for controlling operations of a Universal Serial Bus (USB) device includes a frequency converter, a USB PHY, and a USB core. The circuit is provided with a first clock having a first frequency, where the first frequency is not a factor of a USB specified frequency. The frequency converter converts the first clock into a basic clock having a basic frequency, where the basic frequency is a factor of the USB specified frequency. The USB PHY is coupled to the frequency converter and operates based upon the basic clock and allows the USB device to communicate with an external USB apparatus. The USB core is coupled to the USB PHY and controls parallel data transferred between the USB core and the USB PHY.

### BACKGROUND

The embodiments relate to Universal Serial Bus (USB), and more particularly, to circuits for controlling operations of USB devices.

Universal Serial Bus (USB) is a connectivity specification developed by some technology industry leaders and provides ease of use, expandability, and speed for the end users. Originally released in 1995 at 12 Mbps, USB today operates at 480 Mbps and can be found in many kinds of electrical devices.

FIG. 1 shows a circuit for controlling operations of a USB device. The circuit 100 is realized by a System On a Chip (SOC) and comprises three major functional blocks: an application-specific circuit 120, a USB core 140, and a USB PHY 160. A USB 2.0 Transceiver Macrocell Interface (UTMI) and a UTMI+Low Pin Interface (ULPI) serve as examples of an inner interface that allows 8-bit/16-bit parallel data to be transferred between the USB core 140 and the USB PHY 160. The application-specific circuit 120 controls the primary functions of the USB device. The USB core 140 serves as a Central Processing Unit (CPU) and a Dynamic Random Access Memory (DRAM) controller that manage 8-bit/16-bit parallel data transfer on the aforementioned inner interface. The USB PHY 160 comprises a serial interface engine (SIE) 162 and a phase lock loop (PLL) 164 and allows the USB device to communicate with an external USB apparatus 90, such as a USB host or a USB peripheral.

In addition to the circuit 100, the USB device further comprises a first clock source 20 that provides a first clock CK1 to the application-specific circuit 120. With the first clock source 20, the application-specific circuit 120 is allowed to function based upon the first clock CK1. For the most part, the frequency of the first clock CK1 is not a factor of 480 MHz, where 480 MHz is termed as a USB specified frequency in the following paragraphs. At least one pad of the circuit 100 is needed to interconnect the first clock source 20 and the circuit 100.

According to the related specifications, the PLL 164 is responsible for providing a 480-MHz reference clock RCK1 to the SIE 162 and providing a 12/30/60-MHz reference clock RCK2 to the USB core 140. The accuracy requirements on the 480-MHz clock RCK1 are quite strict. For example, the jitter in the 480-MHz clock RCK1 is restricted to be less than 5%. To meet the strict accuracy requirements, an additional clock source 40 must be included in the USB device to provide a second clock CK2 to the PLL 164, where the frequency of the second clock CK2 is required to be exactly a factor of 480 MHz. Furthermore, the PLL 164 must be realized by a refined circuit that precisely converts the second clock CK2 into the 480-MHz clock RCK1 and the Dec. 30, 1960-MHz clock RCK2.

However, using the second clock source 40 to provide the second clock CK2 to the PLL 164 requires the circuit 100 to use additional pads to interconnect itself with the second clock source 40. The additionally included second clock source 40, the additional used pads that interconnect the circuit 100 with the second clock source 40, and the refined circuit that realizes the PLL 164 inevitably cause the overall cost of the USB device to be increased. Therefore, the structure shown in FIG. 1 is not an optimal one appreciated by some cost-conscious manufacturers.

### SUMMARY

According to the embodiments, a circuit that controls operations of a Universal Serial Bus (USB) device is disclosed. The circuit is provided with a first clock having a first frequency, where the first frequency is not a factor of a USB specified frequency. The circuit comprises a frequency converter, a USB PHY, and a USB core. The frequency converter converts the first clock into a basic clock having a basic frequency, where the basic frequency is a factor of the USB specified frequency. The USB PHY is coupled to the frequency converter and operates based upon the basic clock and allows the USB device to communicate with an external USB apparatus. The USB core is coupled to the USB PHY and controls parallel data transferred between the USB core and the USB PHY.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a circuit for controlling operations of a USB device.

FIG. 2 shows a circuit for controlling operations of a USB device according to an embodiment.

FIG. 3 shows exemplary block diagrams of the frequency converter shown in FIG. 2 according to some embodiments.

FIG. 4 shows a circuit for controlling operations of a USB device according to another embodiment.

FIG. 5, FIG. 6, and FIG. 7 show exemplary block diagrams of the frequency converter shown in FIG. 4 according to some embodiments.

### DETAILED DESCRIPTION

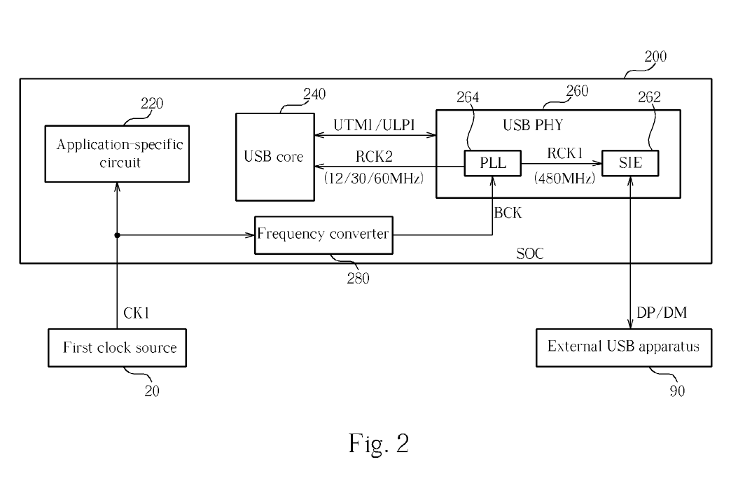

FIG. 2 shows a circuit for controlling operations of a USB device according to an embodiment. The circuit 200 of this embodiment is realized by a System On a Chip (SOC) and comprises four major functional blocks: an application-specific circuit 220, a USB core 240, a USB PHY 260, and a frequency converter 280. A USB 2.0 Transceiver Macrocell Interface (UTMI) and a UTMI+Low Pin Interface (ULPI) serves as examples of an inner interface that allows parallel data to be transferred between the USB core 240 and the USB PHY 260. The application-specific circuit 220 controls the primary functions of the USB device. The USB core 240 serves as a Central Processing Unit (CPU) and a Dynamic Random Access Memory (DRAM) controller that manage parallel data transfer on the aforementioned inner interface. The USB PHY 260 comprises a serial interface engine (SIE) 262 and a phase lock loop (PLL) 264 and allows the USB device to communicate with an external USB apparatus 90, such as a USB host or a USB peripheral.

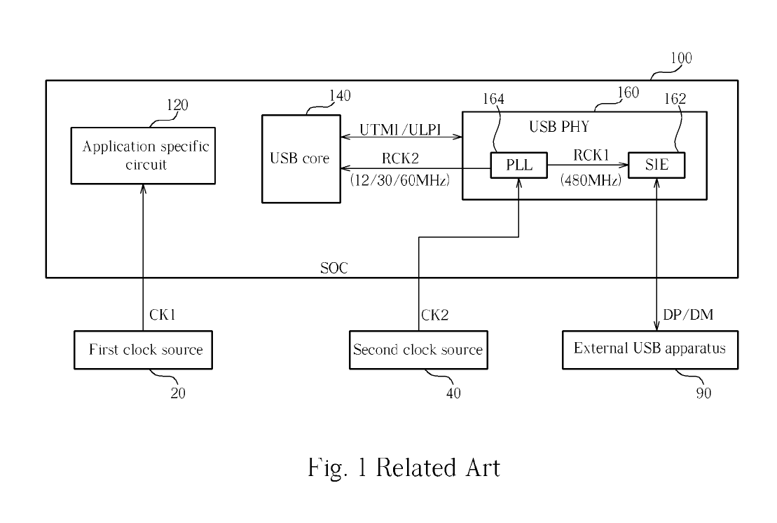

Comparing with the circuit 100 of the related art, the circuit 200 of this embodiment does not demand an additional clock source, such as the second clock source 40 shown in FIG. 1, to provide an additional clock having a frequency that is exactly a factor of a USB specified frequency, where the USB specified frequency is 480 MHz in this example. On the contrary, the circuit 200 of this embodiment demands only an external clock source(s), such as the first clock source 20 shown in FIG. 2, to provide a clock(s) required by the application-specific circuit 220. The circuit 200 then utilizes one of the externally provided clock(s), such as the existing first clock CK1 shown in FIG. 2, as a basis to generate a basic clock BCK required by the USB PHY 260. Since the second clock source 40 and a pad(s) that connect the circuit 200 and the second clock source 40 are excluded, the overall cost of the USB device of this embodiment is decreased.

Specifically, in this embodiment the frequency converter 280 is responsible for converting the existing first clock CK1 into the basic clock BCK having a basic frequency. The basic frequency is a factor of 480 MHz, and therefore allows the PLL 264 to generate a 480-MHz USB specified clock RCK1 required by the SIE 262 and a Dec. 30, 1960-MHz clock RCK2 that synchronizes parallel data transferred between the USB core 240 and the USB PHY 260.

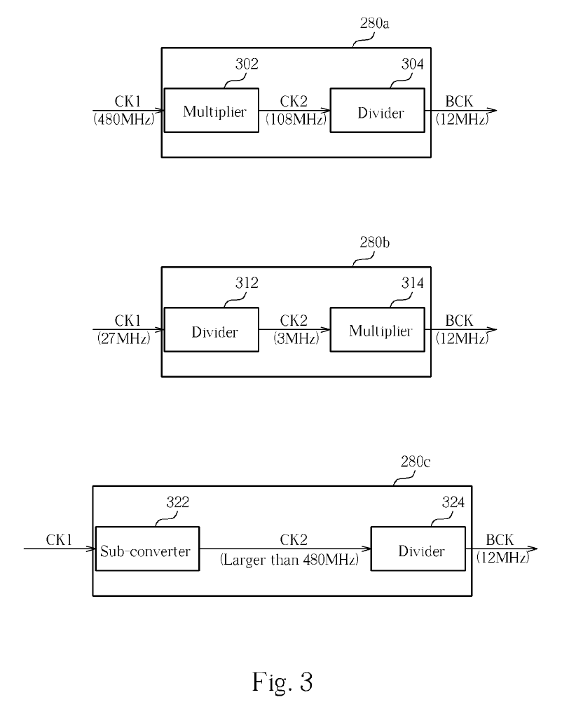

Generally speaking, the frequency converter 280 can be realized by inexpensive digital logic, including multipliers realized by Phase Lock Loop (PLLs) or Delay Lock Loops (DLLs) and dividers realized by counters. Some exemplary block diagrams of the frequency converter 280 are shown in FIG. 3. In the upper example of FIG. 3, the first frequency is 27 MHz and the frequency converter 280a comprises a multiplier 302 and a divider 304. The multiplier 302 converts the first clock CK1 into a second clock CK2 having a second frequency, which is 108 MHz in this example. The second frequency and the USB specified frequency have a common factor, i.e. 12 MHz in this example. The divider 304 converts the second clock CK2 into the basic clock BCK having the basic frequency. The basic frequency is 12 MHz in this example being a factor of 480 MHz. The basic clock BCK is then provided to the PLL 264 and allows the PLL 264 to generate the clocks RCK1 and RCK2 accordingly.

In the center example of FIG. 3, the first frequency is 27 MHz and the frequency converter 280b comprises a divider 312 and a multiplier 314. The divider 312 converts the first clock CK1 into a second clock CK2 having a second frequency, which is 3 MHz in this example. The second frequency is a factor of the USB specified frequency. The multiplier 314 converts the second clock CK2 into the basic clock BCK having the basic frequency, which is 12 MHz in this example. The basic clock BCK is then provided to the PLL 264 and allows the PLL 264 to generate the clocks RCK1 and RCK2 accordingly.

In the lower example of FIG. 3, the frequency converter 280c comprises a sub-converter 322 and a divider 324. The sub-converter 322 is made up of a multiplier(s) and/or a divider(s) and converts the first clock CK1 into a second clock CK2 having a second frequency. The second frequency is larger than the USB specified frequency. The divider 324 converts the second clock CK2 down to the basic clock BCK having the basic frequency, which is a factor of 480 MHz. The basic clock BCK is then provided to the PLL 264 and allows the PLL 264 to generate the clocks RCK1 and RCK2 accordingly.

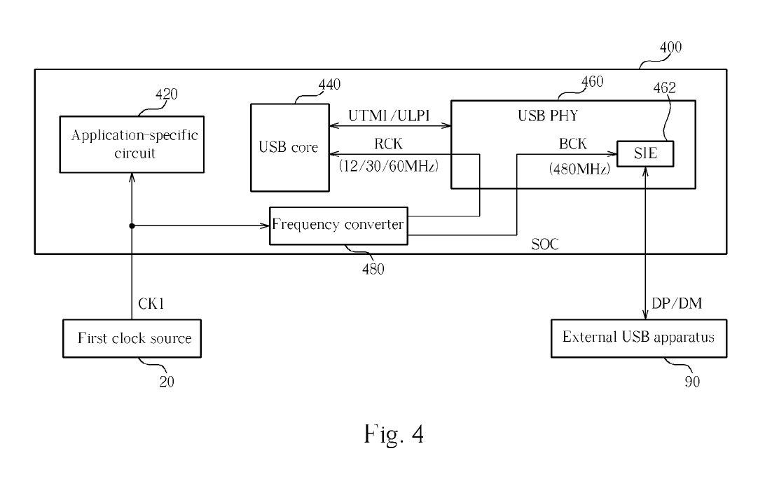

FIG. 4 shows a circuit for controlling operations of a USB device according to another embodiment. The circuit 400 of this embodiment is similar to the circuit 200 shown in FIG. 2, except for the USB PHY 460 of the circuit 400 does not comprise a PLL as the USB PHY 260 does. Furthermore, the frequency converter 480 is responsible for converting the first clock CK1 into not only a basic clock BCK but also a 12/30/60-MHz clock RCK. The basic clock is provided to the SIE 462. The 12/30/60-MHz clock RCK allows parallel data transferred between the USB core 440 and the USB PHY 460 to be synchronized.

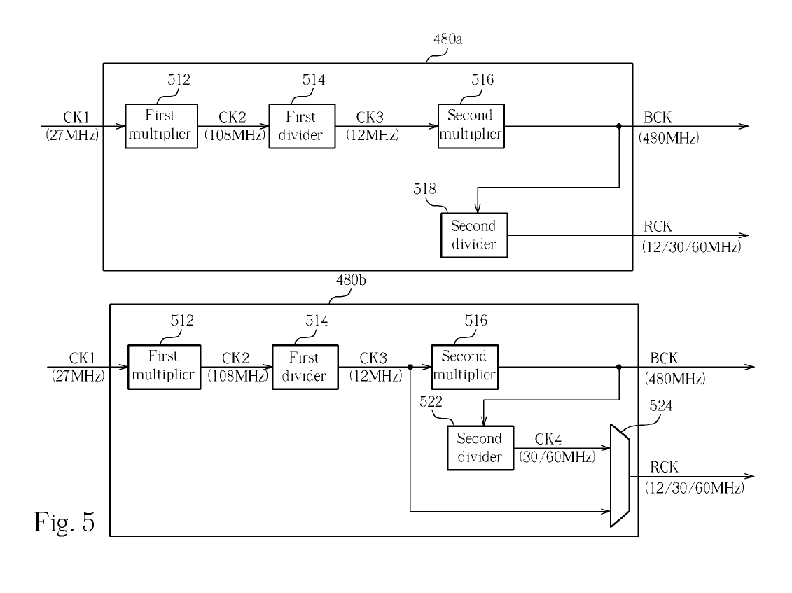

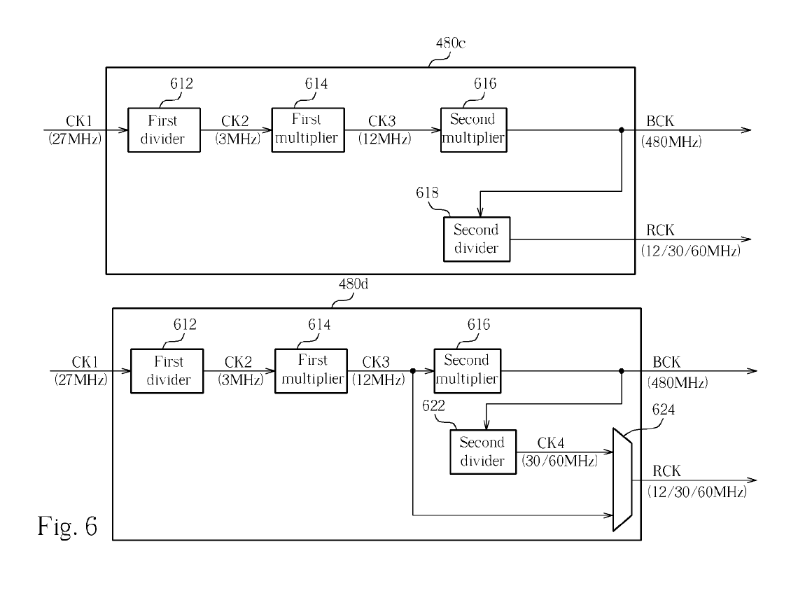

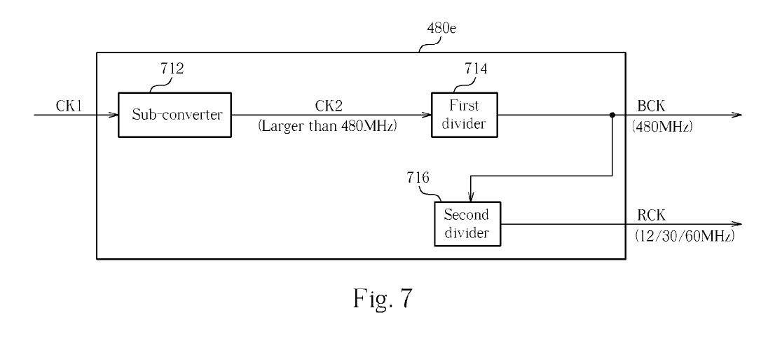

Generally speaking, the frequency converter 480 can be realized by inexpensive digital logic, including multipliers realized by Phase Lock Loop (PLLs) or Delay Lock Loops (DLLs), dividers realized by counters, and multiplexers. Some exemplary block diagrams of the frequency converter 480 are shown in FIG. 5, FIG. 6, and FIG. 7. In the upper example of FIG. 5, the first frequency is 27 MHz and the frequency converter 480a comprises a first multiplier 512, a first divider 514, a second multiplier 516, and a second divider 518. The first multiplier 512 converts the first clock CK1 into a second clock CK2 having a second frequency, which is 108 MHz in this example. The second frequency and the USB specified frequency have a common factor, i.e. 12 MHz in this example. The first divider 514 converts the second clock CK2 into a third clock CK3 having a third frequency, which is 12 MHz in this example and is a factor of 480 MHz. The second multiplier 516 converts the third clock CK3 into the basic clock BCK having the basic frequency, which is 480 MHz in this example. The basic clock BCK is then provided to the USB PHY 460 and allows the SIE 462 to function accordingly. The second divider 518 is a variable divider that utilizes 40, 16, or 8 as a divisor to convert the basic clock BCK into a fourth clock RCK having a fourth frequency, which is 12, 30, or 60 MHz. The fourth clock RCK is then provided to the USB PHY 460 and allows parallel data transferred between the USB core 440 and the USB PHY 460 to be synchronized.

Similar to the frequency converter 480a, the frequency converter 480b shown in the lower side of FIG. 5 also comprises the first multiplier 512, the first divider 514, and the second multiplier 516. In addition, the frequency converter 480b further comprises a second divider 522 and a multiplexer 524. The second divider 522 of this example is a variable divider that utilizes either 16 or 8 as a divisor to convert the basic clock BCK into a fourth clock CK4 having a fourth frequency, which is either 30 MHz or 60 MHz. The multiplexer 524 selectively outputs the third clock CK3 or the fourth clock CK4 as a fifth clock RCK having a fifth frequency. The fifth frequency is 12, 30, or 60 MHz. The fifth clock RCK is then provided to the USB PHY 460 and allows parallel data transferred between the USB core 440 and the USB PHY 460 to be synchronized.

In the upper example of FIG. 6, the first frequency is 27 MHz and the frequency converter 480c comprises a first divider 612, a first multiplier 614, a second multiplier 616, and a second divider 618. The first divider 612 converts the first clock CK1 into a second clock CK2 having a second frequency, which is 3 MHz and is a factor of 480 MHz in this example. The first multiplier 614 converts the second clock CK2 into a third clock CK3 having a third frequency. The third frequency is 12 MHz in this example and is a factor of 480 MHz. The second multiplier 616 converts the third clock CK3 into the basic clock BCK having the basic frequency, which is 480 MHz in this example. The basic clock BCK is then provided to the USB PHY 460 and allows the SIE 462 to function accordingly. The second divider 618 is a variable divider that utilizes 40, 16, or 8 as a divisor to convert the basic clock BCK into a fourth clock RCK having a fourth frequency, which is 12, 30, or 60 MHz. The fourth clock RCK is then provided to the USB PHY 460 and allows parallel data transferred between the USB core 440 and the USB PHY 460 to be synchronized.

Similar to the frequency converter 480c, the frequency converter 480d shown in the down side of FIG. 6 also comprises the first divider 612, the first multiplier 614, and the second multiplier 616. In addition, the frequency converter 480d further comprises a second divider 622 and a multiplexer 624. The second divider 622 of this example is a variable divider that utilizes either 16 or 8 as a divisor to convert the basic clock BCK into a fourth clock CK4 having a fourth frequency. The fourth frequency is either 30 MHz or 60 MHz. The multiplexer 524 selectively outputs the third clock CK3 or the fourth clock CK4 as a fifth clock RCK having a fifth frequency, which is 12, 30, or 60 MHz. The fifth clock RCK is then provided to the USB PHY 460 and allows parallel data transferred between the USB core 440 and the USB PHY 460 to be synchronized.

In the example shown in FIG. 7, the frequency converter 480e comprises a sub-converter 712, a first divider 714, and a second divider 716. The sub-converter 712 is made up of a multiplier(s) and/or a divider(s) and converts the first clock CK1 into a second clock CK2 having a second frequency. The second frequency is larger than the USB specified frequency in this example. The first divider 714 converts the second clock CK2 down to the basic clock BCK having the basic frequency, which is 480 MHz in this example. The basic clock BCK is then provided to the USB PHY 460 and allows the SIE 462 to function accordingly. The second divider 716 is a variable divider that utilizes 40, 16, or 8 as a divisor to convert the basic clock BCK into a third clock RCK having a third frequency. The third frequency is 12, 30, or 60 MHz. The third clock RCK is then provided to the USB PHY 460 and allows parallel data transferred between the USB core 440 and the USB PHY 460 to be synchronized.

The aforementioned embodiments do not demand an additional clock source, such as the second clock source 40 shown in FIG. 1, to provide an additional clock that is exactly a factor of 480 MHz. On the other hand, the embodiments make use of an existing first clock, the frequency of which is not a factor of 480 MHz, to generate the clock(s) required by the USB PHYs and the USB cores. Since the second clock source 40 and pad(s) that connects the circuits to the second clock source are excluded, the overall cost of the USB devices of the embodiments are decreased.

Please note that the frequency values mentioned in the above paragraphs and shown in the figures only serve as examples. The clocks in the embodiments can also have other frequency values.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A circuit for controlling operations of a Universal Serial Bus (USB) device, the circuit being provided with a first clock having a first frequency, the first frequency not being a factor of a USB specified frequency, the circuit comprising:
a frequency converter, for converting the first clock into a basic clock having a basic frequency, the basic frequency being a factor of the USB specified frequency;
a USB PHY coupled to the frequency converter, the USB PHY operating based upon the basic clock and allowing the USB device to communicate with an external USB apparatus; and
a USB core coupled to the USB PHY, for controlling parallel data transferred between the USB core and the USB PHY.

2. The circuit of claim 1, wherein the frequency converter comprises:
a multiplier, for converting the first clock into a second clock having a second frequency, the second frequency and the USB specified frequency having at least one common factor; and
a divider coupled to the multiplier and the USB PHY, for converting the second clock into the basic clock having the basic frequency.

3. The circuit of claim 2, wherein the USB PHY comprises:
a serial interface engine (SIE), for allowing the USB device to communicate with the external USB apparatus; and
a phase lock loop (PLL) coupled to the divider and the SIE, for converting the basic clock into the a USB specified clock having the USB specified frequency, the USB specified clock being provided to the SIE and allowing the SIE to operate accordingly.

4. The circuit of claim 1, wherein the frequency converter comprises:
a divider, for converting the first clock into a second clock having a second frequency, the second frequency being a factor of the USB specified frequency; and
a multiplier coupled to the divider and the USB PHY, for converting the second clock into the basic clock having the basic frequency.

5. The circuit of claim 4, wherein the USB PHY comprises:
a serial interface engine (SIE), for allowing the USB device to communicate with the external USB apparatus; and
a phase lock loop (PLL) coupled to the multiplier and the SIE, for converting the basic clock into the a USB specified clock having the USB specified frequency, the USB specified clock being provided to the SIE and allowing the SIE to operate accordingly.

6. The circuit of claim 1, wherein the frequency converter comprises:
a sub-converter, for converting the first clock into a second clock having a second frequency, the second frequency being larger than the USB specified frequency; and
a divider coupled to the sub-converter and the USB PHY, for converting the second clock into the basic clock having the basic frequency.

7. The circuit of claim 6, wherein the USB PHY comprises:
a serial interface engine (SIE), for allowing the USB device to communicate with the external USB apparatus; and
a phase lock loop (PLL) coupled to the divider and the SIE, for converting the basic clock into the a USB specified clock having the USB specified frequency, the USB specified clock being provided to the SIE and allowing the SIE to operate accordingly.

8. The circuit of claim 1, wherein the frequency converter comprises:
a first multiplier, for converting the first clock into a second clock having a second frequency, the second frequency and the USB specified frequency having at least one common factor;
a first divider coupled to the first multiplier, for converting the second clock into a third clock having a third frequency, the third frequency being a factor of the USB specified frequency; and
a second multiplier coupled to the first divider, for converting the third clock into the basic clock having the basic frequency, the basic frequency being equal to the USB specified frequency.

9. The circuit of claim 8, wherein the frequency converter further comprises:
a second divider coupled to the second multiplier and the USB PHY, for converting the basic clock into a fourth clock having a fourth frequency, the fourth clock being provided to the USB PHY and allowing the parallel data transferred between the USB core and the USB PHY to be synchronized.

10. The circuit of claim 8, wherein the frequency converter further comprises:
a second divider coupled to the second multiplier, for converting the basic clock into a fourth clock having a fourth frequency; and
a multiplexer coupled to the first divider, the second divider, and the USB PHY, for selectively outputting the third clock or the fourth clock to the USB PHY as a fifth clock, the fifth clock allowing the parallel data transferred between the USB core and the USB PHY to be synchronized.

11. The circuit of claim 1, wherein the frequency converter comprises:
a first divider, for converting the first clock into a second clock having a second frequency, the second frequency being a factor of the USB specified frequency;
a first multiplier coupled to the first divider, for converting the second clock into a third clock having a third frequency, the third frequency being a factor of the USB specified frequency; and
a second multiplier coupled to the first multiplier, for converting the third clock into the basic clock having the basic frequency, the basic frequency being equal to the USB specified frequency.

12. The circuit of claim 11, wherein the frequency converter further comprises:
a second divider coupled to the second multiplier and the USB PHY, for converting the basic clock into a fourth clock having a fourth frequency, the fourth clock being provided to the USB PHY and allowing the parallel data transferred between the USB core and the USB PHY to be synchronized.

13. The circuit of claim 11, wherein the frequency converter further comprises:
a second divider coupled to the second multiplier, for converting the basic clock into a fourth clock having a fourth frequency; and
a multiplexer coupled to the first multiplier, the second divider, and the USB PHY, for selectively outputting the third clock or the fourth clock to the USB PHY as a fifth clock, the fifth clock allowing the parallel data transferred between the USB core and the USB PHY to be synchronized.

14. The circuit of claim 1, wherein the frequency converter comprises:
a sub-converter, for converting the first clock into a second clock having a second frequency, the second frequency being larger than the USB specified frequency; and
a first divider coupled to the sub-converter and the USB PHY, for converting the second clock into the basic clock having the basic frequency, the basic frequency being equal to the USB specified frequency.

15. The circuit of claim 14, wherein the frequency converter further comprises:
a second divider coupled to the first divider and the USB PHY, for converting the basic clock into a third clock having a third frequency, the third clock being provided to the USB PHY and allowing the parallel data transferred between the USB core and the USB PHY to be synchronized.

16. The circuit of claim 1, wherein the USB specified frequency is 480 MHz.

17. The circuit of claim 1, wherein the USB PHY is a USB 2.0 Transceiver Macrocell (UTM).

18. The circuit of claim 17 further comprising a USB 2.0 Transceiver Macrocell Interface (UTMI) that interconnects the USB PHY and the USB core.

19. The circuit of claim 17 further comprising a UTMI+Low Pin Interface (ULPI) that interconnects the USB PHY and the USB core.

20. The circuit of claim 1, further comprising:
an application-specific circuit operating based on the first clock and controlling the primary functions of the USB device.
